(19) United States
(12) Patent Application Publication
(10) Pub. No.: US 2018/0299189 A1
(43) Pub. Date: Oct. 18, 2018

(54) Appliance Gasket With Non-Attached Internal Component

(71) Applicant: Haier US Appliance Solutions, Inc., Wilmington, DE (US)

(72) Inventor: Eric Gerard Johnson, New Albany, IN (US)

(21) Appl. No.: 15/488,573

(22) Filed: Apr. 17, 2017

(51) Int. Cl. F25D 23/08; F16J 15/10; F16J 15/02

(52) U.S. Cl. CPC F25D 23/087; F16J 15/102; F16J 15/025; F16J 15/027; F16J 15/104

(57) ABSTRACT

A resilient gasket having a multi-piece construction that can be readily manufactured. The gasket includes a body having at least one, non-attached component positioned inside that provides additional resiliency. The body and the non-attached, internal component can be constructed from materials having different properties so as to determine or tune the overall resiliency of the gasket. The gasket can be provided as rails surrounding an opening of the appliance.

### FIELD OF THE INVENTION

The subject matter of the present disclosure relates generally to a gasket for an appliance and, more particularly, a resilient gasket for a door of an appliance.

### BACKGROUND OF THE INVENTION

Appliances frequently use gaskets to seal the opening of a compartment. For example, the fresh food compartment or freezer compartment of a refrigerator is typically accessible through an opening. Access to the opening may be determined by a door connected by hinges to the rest of the appliance or the door may form part of a drawer. Similarly, the wash compartment of a dishwasher or washing machine is accessed by an opening having a door.

In each example, typically a gasket is positioned on the door, or on the body of the appliance. The gasket is positioned so that when the door is in a closed position, the gasket provides a seal around the opening. The seal may prevent liquids from leaking out of the appliance, may prevent ambient air from leaking into the appliance, may prevent energy losses by e.g., preventing warm air from leaking into the appliance and cold air from leaking out of the appliance, and combinations thereof. The gasket may have a shape that is compressed when the door is closed. The compression of the gasket may help to form a seal around the door by closing off any gaps between the door and surfaces around the opening of the appliance. When the door is open, preferably the gasket returns to its original shape because the gasket is no longer compressed between the door and the surface surrounding the opening.

During operation of the appliance, users will frequently open and close the door to access the compartment. Such opening and closing places the gasket in and out of contact with the surface of the appliance surrounding the opening of the compartment being accessed. For a typical gasket, this contact causes the gasket to be flexed. Specifically, the gasket may be compressed, extended, or both as the door is opened and closed. As a result, after a period of time, the gasket may show signs of wear or fatigue. Particularly, cracks may develop along various portions of the gasket particularly at high stress locations where the gasket is bent or flexed from closing and opening of the door.

The gasket may also stay compressed for long periods of time. For example, between the time of manufacture and purchase by the consumer, the door of the appliance may remain closed—causing the gasket to stay compressed. Depending on the length of time, the gasket may develop “memory.” In such case, upon opening the door, the gasket fails to return to its original shape. Instead, the gasket retains, in whole or in part, a compressed shape—as if the door was still in a closed position. When the gasket remains compressed, it may leave gaps or openings between the door and the sealing surface of the appliance when the door is closed—resulting in undesired leaks.

The manufacture of the gasket presents certain challenges as well. Conventionally, the gasket could be constructed of foam. In still another example, the gasket may have an internal chamber and formed by extruding a single piece of material forming the gasket. The conventional extrusion process using a die significantly limits the configurations that can be used for the internal chamber.

Accordingly, a gasket with one or more features that improve the lifetime of the gasket would be useful. Such a gasket with improved resiliency and resistance to wear and memory would be particularly helpful. Such a gasket than can be readily manufactured would be beneficial.

### BRIEF DESCRIPTION OF THE INVENTION

The present invention provides a resilient gasket having a multi-piece construction that can be readily manufactured. The gasket includes a body having at least one, non-attached component positioned inside that provides additional resiliency. The body and the non-attached, internal component can be constructed from materials having different properties so as to determine or tune the overall resiliency of the gasket. The gasket can be provided as rails surrounding an opening of the appliance. Additional aspects and advantages of the invention will be set forth in part in the following description, or may be apparent from the description, or may be learned through practice of the invention.

In one exemplary embodiment, the present invention provides a resilient gasket for an appliance. The gasket defines a longitudinal direction. The gasket includes a main body with a base having an attachment side and a sealing side that is opposite to the attachment side. The attachment side provides an attachment surface for attachment to a body of the appliance.

A dart protrudes from the attachment side of the base and is configured for insertion into the appliance. A pocket is attached to the sealing side of the base. The pocket provides a sealing surface for contact around an opening of the appliance. The pocket defines a chamber on the sealing side of the base.

At least one internal component is located within the chamber of the pocket. The internal component not attached to the main body. The main body and the internal component each extend along the longitudinal direction of the gasket.

In another exemplary aspect, the present invention provides a gasket for an appliance having a door providing access to one or more compartments of the appliance through an opening. The appliance defines lateral, transverse, and vertical directions. The gasket includes a plurality of rails configured to surround the opening when the door is in a closed position. Each rail is connected with at least two adjacent rails, and each rail extends linearly along a longitudinal direction.

For this exemplary embodiment, at least one of the rails includes a main body that includes a base having an attachment side and a sealing side that is opposite to the attachment side. The attachment side provides an attachment surface for attachment to a body of the appliance. A dart protrudes orthogonally from the attachment side of the base and is configured for attaching the gasket to the appliance. A pocket is attached to the sealing side of the base and provides a sealing surface for contact around an opening of the appliance. The pocket defines a chamber on the sealing side of the base. At least one internal component is located within the chamber of the pocket. The internal component not attached to the main body.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an exemplary embodiment of an appliance as may be equipped with an exemplary gasket of the present invention.

FIG. 2 is a front view of the exemplary embodiment of an appliance shown in FIG. 1.

FIG. 3 is a view of an exemplary embodiment of a gasket of the present invention as viewed from a sealing side.

FIG. 4 is a cross-sectional view of the exemplary gasket of FIG. 3 in a non-compressed state.

FIG. 5 is a cross-sectional view of another exemplary gasket of the present invention in a non-compressed state.

FIG. 6 is a cross-sectional view of another exemplary gasket of the present invention in a non-compressed state.

FIG. 7 is a cross-sectional view of another exemplary gasket of the present invention in a non-compressed state.

The use of the same or similar features in the reference numerals denotes the same or similar features unless otherwise indicated.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

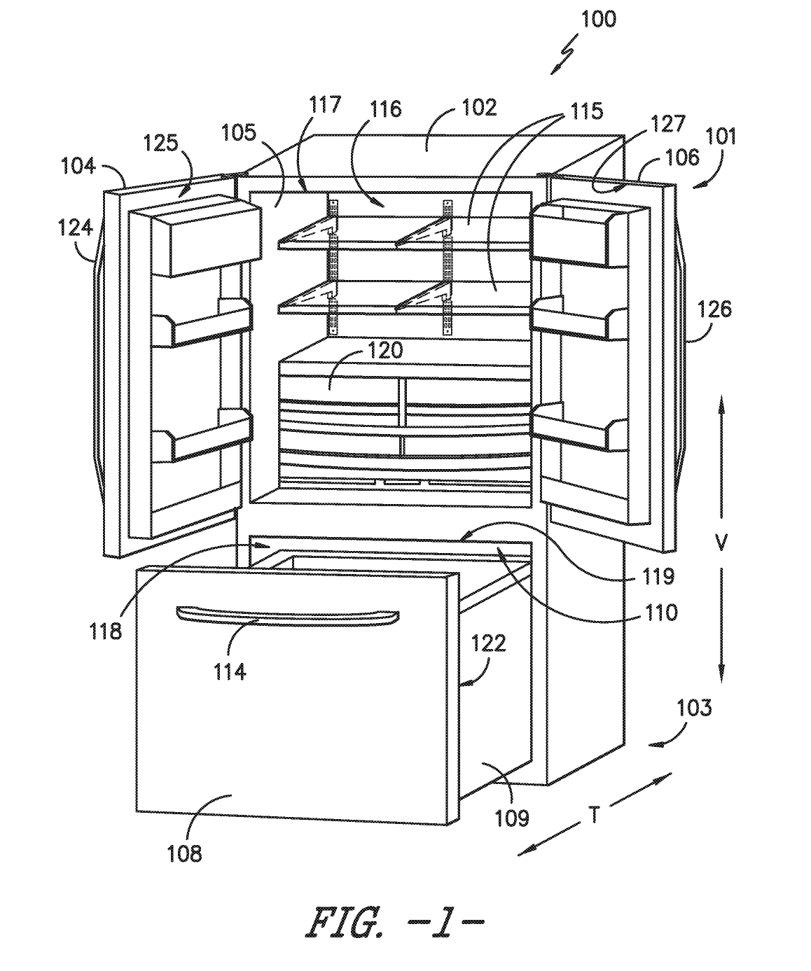

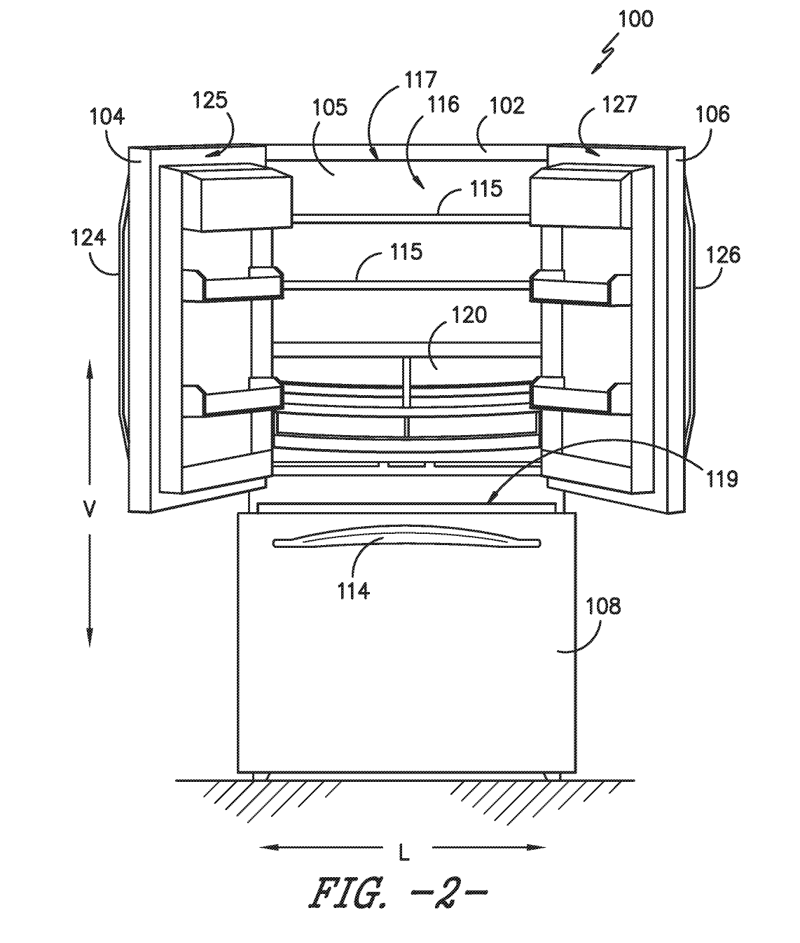

FIG. 1 provides a perspective view of a refrigerator appliance 100 according to an exemplary embodiment of the present disclosure. FIG. 2 provides a front, elevation view of refrigerator appliance 100. In the description that follows, refrigerator appliance 100 will be used for purposes of describing exemplary embodiments of the invention. Using the teachings disclosed herein, one of ordinary skill in the art will understand that the present invention may be used with other appliances as well including e.g., dishwashers, washing machines, and others.

In both FIGS. 1 and 2, doors 104, 106, and 108 are shown in an open position. Refrigerator appliance 100 includes a housing or cabinet 102 that extends between a top portion 101 and a bottom portion 103 along a vertical direction V. Cabinet 102 also extends along a lateral direction L and a transverse direction T. The vertical direction V, lateral direction L, and transverse direction T are mutually perpendicular to one another and form an orthogonal direction system.

Cabinet 102 includes a liner 105 that defines chilled chambers for receipt of food items for storage. In particular, liner 105 defines compartments that include a fresh food chamber 116 positioned at or adjacent top 101 of cabinet 102 and a freezer chamber 118 arranged at or adjacent bottom 103 of cabinet 102. Each chamber 116, 118 may be provided with various features such as e.g., shelves 115. Refrigerator appliance 100 is generally referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or others. Additionally, refrigerator appliance 100 could be provided with other features such as e.g., a dispensing assembly for dispensing liquid water and/or ice, a user interface for controlling or selecting various features, and still other features as well.

Refrigerator doors 104, 106 are rotatably hinged to an edge of cabinet 102 for selectively accessing fresh food chamber 116 through opening 117 defined by inner liner 105. Handles 124 and 126 allow a user to selectively open and close doors 104 and 106. Freezer door 108 is arranged below refrigerator doors 104, 106 for selectively accessing freezer chamber 118 through opening 119. Freezer door 108 is coupled to a freezer drawer 109 slidably mounted within freezer chamber 118.

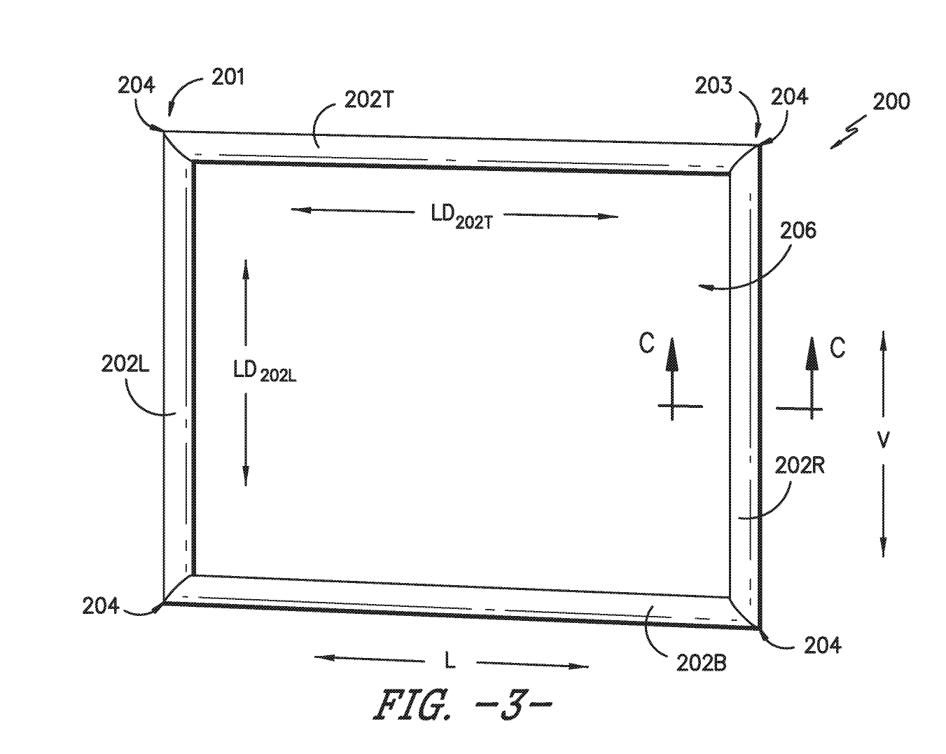

FIG. 3 illustrates an exemplary embodiment of a resilient gasket 200 of the present invention. As illustrated, for this embodiment gasket 200 is configured as a plurality of rails 202T, 202B, 202L, and 202R that surround an opening 206. Each rail 202 is connected with at least two adjacent rails. Each rail 202 extends linearly along a longitudinal direction. For example, rail 202T defines a longitudinal direction LD_{202T} along which rail 202T extends in a linear manner. Rail 202L defines a longitudinal direction LD_{202L} along which rail 202L extends in a linear manner. Rail 202T, for example, is connected at opposing ends 201 and 203 to rails 202L and 202R respectively. Rails 202 may be connected together by e.g., welds 204 created by heating so as to fuse the rails together. Other constructions and methods of connection may be used as well.

Gasket 200 may be placed around an opening in an appliance to provide a seal against fluid leaks (whether gas or liquid), energy leaks, or both. For example, gasket 200 could be placed around opening 117 of fresh food compartment 116. Another gasket 200 could be placed around opening 119 of freezer compartment 118. Gasket 200 could be positioned on cabinet 102 and/or inner liner 105 around openings 117 and 119. Alternatively, gasket 200 could be mounted to door 108 at surface 122, door 104 at surface 145, and/or door 106 at surface 127. Although shown in rectangular form in FIG. 3, gasket 200 can be provided in other shapes and configurations as well.

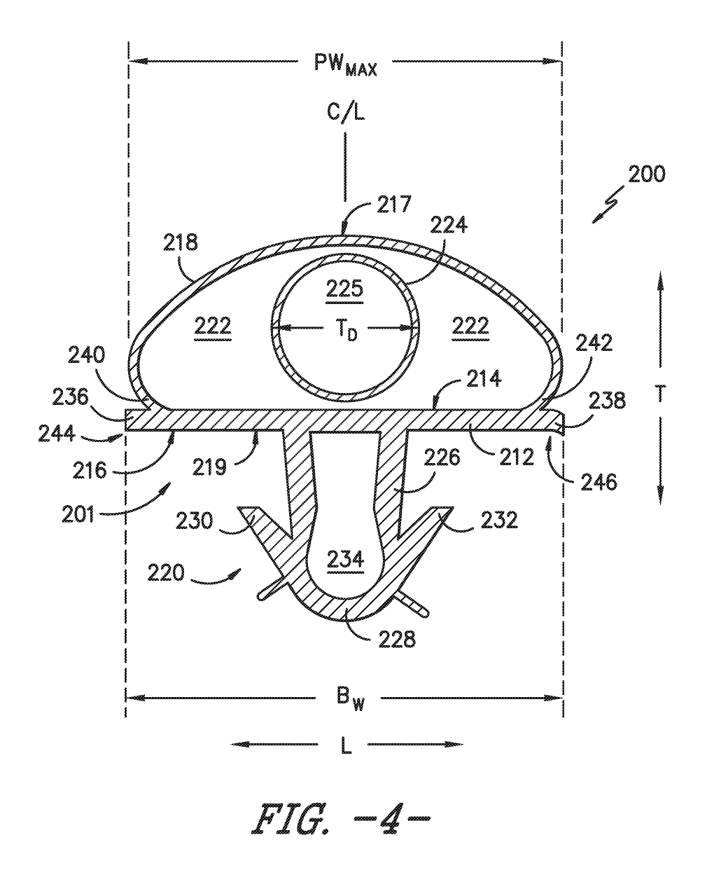

FIG. 4 provides a cross-sectional view along line C-C in FIG. 3 of exemplary resilient gasket 200 in an uncompressed condition. Gasket 200 includes a main body 201 that has a base 212. In turn, base 212 has a sealing side 214 and an attachment side 216 and extends between opposing sides 244 and 246. For this exemplary embodiment, gasket 200 is symmetrical about center line C/L.

Attachment side 216 provides an attachment surface 219 for positioning gasket 200 around e.g., openings 117 or 119 of appliance 100. A dart 220 defining a cavity 234 projects orthogonally from attachment surface 219. Dart 228 includes hooks 230, 232 that extend laterally from dart 228. Dart 228 may extend continuously along the length of gasket 200 or may be formed intermittently along surface 219.

One or more slots or openings can be created in cabinet 102 and/or inner liner 105 for the receipt of dart 220. More particularly, a head 228 of dart 220 is inserted into such openings or slots. During such insertion, the resiliency of dart 220 allows cavity 234 in dart body 226 to collapse as dart 220 is inserted. After insertion, dart 220 can expand and hooks 230, 232 will open within cabinet 102 and/or inner liner 105 to help secure gasket 200 around the opening of the appliance.

Gasket 200 includes a pocket 218 attached to the sealing side 214 of base 212. Pocket 218 provides a sealing surface 217 that extends between intersections 240 and 242 with base 212 on opposing sides 244 and 246 of the centerline C/L of gasket 200. When e.g., one of the doors 104, 106, and/or 108 is in a closed position, sealing surface 217 contacts appliance 100 entirely around a respective opening 117, 119 to provide a fluid seal—i.e. a seal that does not allow air to move in and out of opening 117.

Pocket 218 defines a chamber 222 between sealing surface 217 and base 212. Due to the resiliency of pocket 218, chamber 222 can flatten or partially collapse when a door of the appliance is in a closed position such that pressure is applied against sealing surface 217. When the door is opened by e.g., a user accessing a compartment of the appliance, pocket 218 can return to its original, uncompressed shape as shown in FIG. 4. Pocket 218 extends along the entire length of rail 202 (FIG. 3) of gasket 200. For this exemplary construction of gasket 200, pocket 218 is attached slightly inward of the opposing lateral sides of base 244, 246 so as to create a pair of opposing steps 236, 238.

A resilient internal component 224 is positioned within chamber 222. Notably, internal component 224 is not attached to main body 201 or any other part of gasket 200. For example, main body 201 and internal component 224 may be extruded separately and, afterwards, internal component 224 may be readily inserted into chamber 222. Other methods of construction may be used as well. Internal component 224 extends along the entire length of a rail 202 (FIG. 3) of gasket 200. In other constructions, internal component 224 may extend along only a portion of the entire length of rail 202.

For this exemplary embodiment, the internal component 224 is configured as a tube having an internal component cavity 225 and an outside tube diameter T_{D}, which is also the maximum width of internal component 224. Pocket 218 has a maximum pocket width PW_{MAX} along a direction orthogonal to the longitudinal direction (e.g., LD202_{L} or LD202_{T}) of rail 202. Outside tube diameter T_{D} is less than maximum pocket width PW_{MAX} of pocket 218. In one exemplary embodiment of the invention, T_{D}≤0.5*PW_{MAX} when gasket 200 is in the uncompressed condition as shown in FIG. 4. Other ratios may be used as well.

Additionally, base 212 has a base width B_{W} along a direction orthogonal to the longitudinal direction (e.g., LD202_{L} or LD202_{T}) of rail 202. In one exemplary embodiment, outside tube diameter T_{D} is less than base width B_{W}. In another embodiment, maximum pocket width PW_{MAX} of pocket 218 is less than base width B_{W}. Other constructions may also be used.

Internal component 224 is constructed of a resilient material and provides support for pocket 218. Accordingly, when pocket 218 is compressed, internal component 224 provides an additional spring-like action for pocket 218 that helps gasket 200 maintain a seal even as pocket 218 wears. Specifically, when pocket 218 is compressed as a door of appliance 100 is placed into a closed position, chamber 222 can flatten or collapse but is supported by the resiliency of internal component 224—which helps control the amount of flattening and other deformation of chamber 222. When pocket 218 is uncompressed as a door of appliance 100 is opened, internal component 224 helps return pocket 218 to its original uncompressed state—or close thereto—as shown in FIG. 4. In addition, the resiliency of internal component 224 helps prevent gasket 200 from having memory if pocket 218 is compressed for relatively long periods of time such as e.g., during shipping and warehousing of appliance 200.

Internal component 224 and pocket 218 may be constructed from the same or different materials. For example, plastics such as polyvinyl chloride, polyurethanes, and others may be used for the construction of gasket 200 including pocket 218 and internal component 224. Advantageously, internal pocket 228 and pocket 218 may also be constructed from different materials. More particularly, because internal component 224 is not attached to pocket 218, it may be e.g., extruded separately from a different material having a different resiliency or other properties. Such allows a designer to carefully select or refine the overall resiliency of gasket 200.

For example, internal component 224 can have a first durometer value IC_{D} on the Shore A hardness scale and pocket 218 can have as second durometer value P_{D} on the Shore A hardness scale. As used herein, Shore A hardness refers to a durometer scale identified in ASTM D2240 type A. In one exemplary embodiment of the present invention, first durometer value IC_{D} of internal component 224 is greater than second durometer value P_{D} of pocket 218. In another embodiment, first durometer value IC_{D} of internal component 224 is the same as second durometer value P_{D} of pocket 218. In yet another embodiment, first durometer value IC_{D} of internal component 224 is less than second durometer value P_{D} of pocket 218. In still another embodiment of the invention, first durometer value IC_{D} of internal component 224 may be in the range of about 10 Shore A to about 100 Shore A, and second durometer value P_{D} of pocket 218 may be in the range of about 50 Shore A to 80 Shore A. Other relative values may be used as well.

The resiliency of gasket 200 can also be adjusted by varying the thickness of one or more components. For example, the thickness of main body 201 could be modified. Pocket 218 could be created with e.g., a thicker wall to increase its resiliency. Similarly, internal component 224 could be created with e.g., a thicker wall to increase its resiliency. Other configurations may be used as well.

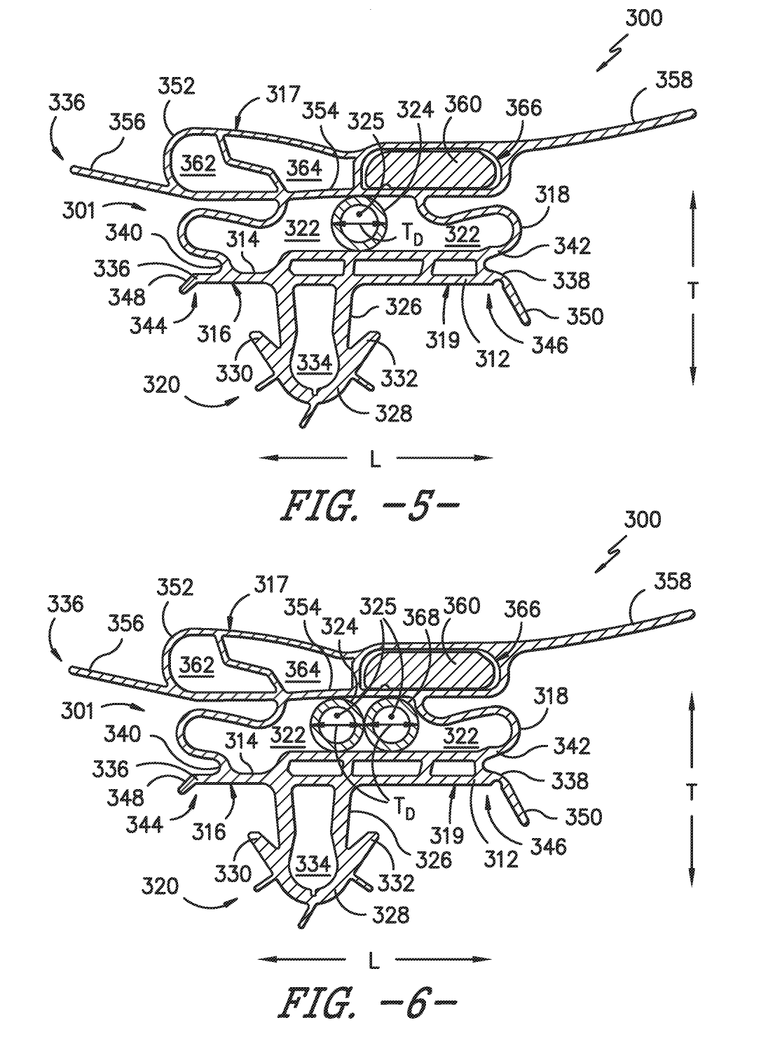

FIG. 5 provides another cross-sectional view of an exemplary embodiment of a gasket 300 of the present invention. As with the embodiment of FIG. 3, gasket 300 includes a base 312 having an attachment side 319 and a sealing side 314. A dart 320 with body 326, cavity 334, and head 328 extends orthogonally from attachment surface 319. Flanges 348 and 350 extend from the opposing pair of lateral steps 336, 338 on each lateral side of gasket 300. Flanges 348 and 350 can help cover portions of inner liner 105 and/or cabinet 102.

Gasket 300 includes a first pocket 318 attached to sealing side 314 of base 312. Pocket 318 defines a chamber 322 into which internal component 324 is received. A secondary pocket 352 is attached to pocket 318 and is divided into secondary chambers 362, 364, and 366. A magnet 360 is contained within secondary chamber 366. Second pocket 352 includes ledges 356 and 358 that extend along lateral direction L from gasket 300. Ledges 356 and 358 can be used to e.g., provide further covering of inner liner 105 or cabinet 102 from a user's view.

Accordingly, as a door of appliance 100 is opened and closed, magnet 360 pulls gasket 300 towards a ferrous component of inner liner 105 and/or cabinet 102 to help form a seal when the door is in the closed position. As with gasket 200, gasket 300 is constructed of one or more resilient materials. In FIG. 5, gasket 300 is shown in a non-compressed condition as it would take when a door of appliance 100 is in an open position. In a closed position, gasket 300 can be compressed so as to flatten or partially collapse pockets 318, 352 and chambers 322, 362, and 364. As with internal component 224, internal component 324 provides additional resiliency and is not attached to any other portion of gasket 300 including base 312 and pocket 318. Additionally, the materials of construction of internal component 324 may be different than pockets 318, 352 allowing for the same or different resiliency (e.g., durometer values) of internal component 324 relative to the other components of gasket 300.

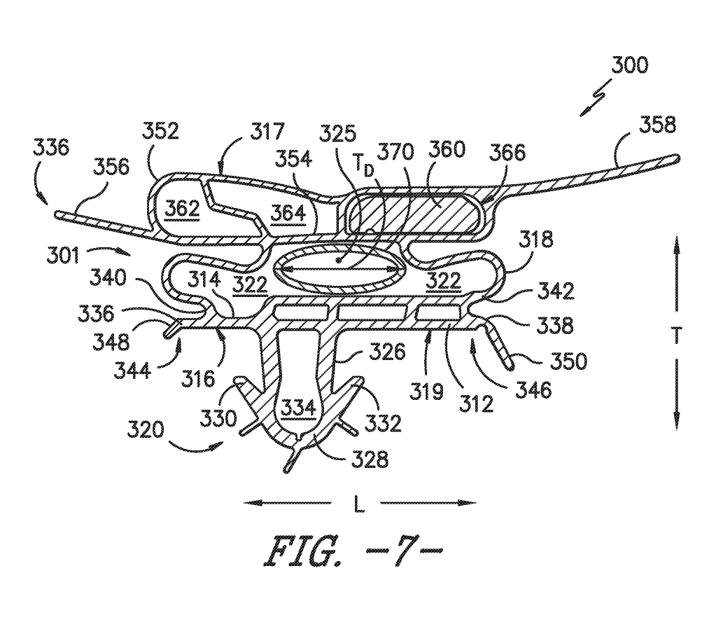

In FIGS. 4 and 5, a single internal component 224, 324 is depicted in gaskets 200, 300, respectively. However, more than one internal component may be used with the gasket of the present invention. Accordingly, FIG. 6 depicts exemplary gasket 300 with two internal components 324 and 368. Each internal component 324, 368 may be constructed from the same or different materials to provide further design options for the resiliency of gasket 300. As with internal component 324, internal component 368 is also not attached to any other portion of gasket 300.

The internal components used in the exemplary gasket of the present invention may have a variety of different shapes, which can affect resiliency. The embodiments of FIGS. 4, 5, and 6 depicted tubular internal components 324, 368 having a circular cross-section as shown. However, other shapes may be used including e.g., square, rectangular, and elliptical as depicted with internal component 370 in FIG. 7. Furthermore, internal components of the present invention can be constructed as shapes connected with each other such as e.g., adjacent tubes that are joined together or extruded together.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A resilient gasket for an appliance, the gasket defining a longitudinal direction, the gasket comprising:
a main body that includes
a base having an attachment side and a sealing side that is opposite to the attachment side, the attachment side providing an attachment surface for attachment to a body of the appliance;
a dart protruding from the attachment side of the base and configured for insertion into the appliance;
a first pocket attached to the sealing side of the base, the first pocket providing a sealing surface for contact around an opening of the appliance, the first pocket defining a first chamber on the sealing side of the base;
a second pocket attached to the first pocket such that the first pocket is located between the second pocket and the base; and
at least one internal component located within the first chamber of the first pocket, the internal component not attached to the main body;
wherein the main body and the internal component each extend along the longitudinal direction of the gasket.

2. The gasket for an appliance as in claim 1, wherein the internal component has a first durometer and the first pocket has a second durometer, and wherein the first durometer is greater than the second durometer.

3. The gasket for an appliance as in claim 1, wherein the internal component has a first durometer and the first pocket has a second durometer, and wherein the first durometer is equal to the second durometer.

4. The gasket for an appliance as in claim 1, wherein the dart extends normal to the attachment side.

5. The gasket for an appliance as in claim 1, wherein the second pocket comprises a plurality of secondary chambers positioned adjacent to each other along a lateral direction that is orthogonal to the longitudinal direction.

6. The gasket for an appliance as in claim 5, further comprising a magnet positioned in one of the second chambers of the second pocket.

7. The gasket for an appliance as in claim 1, wherein the first pocket has a maximum pocket width along a direction orthogonal to the longitudinal direction, and wherein the at least one internal component comprises a tube having a tube diameter that is less than the maximum pocket width.

8. The gasket for an appliance as in claim 1, wherein the at least one internal component comprises a tube not attached to the main body.

9. The gasket for an appliance as in claim 1, wherein the at least one internal component comprises at least two tubes inserted into the first chamber, the at least two tubes not attached to the main body.

10. The gasket for an appliance as in claim 1, wherein the base has a base width along a direction orthogonal to the longitudinal direction of the gasket, and wherein the internal component comprises a tube that has a tube diameter less than the base width.

11. The gasket for an appliance as in claim 1, wherein the base defines a pair of opposing lateral steps, and further comprising a pair of flanges, each flange attached to one of the lateral steps of the base.

12. The gasket for an appliance as in claim 1, wherein the at least one internal component comprises a tube having a cross-sectional shape selected from the group including circular, elliptical, or quadrilateral.

13. A gasket for an appliance having a door providing access to one or more compartments of the appliance through an opening, the appliance defining lateral, transverse, and vertical directions, the gasket comprising:
a plurality of rails configured to surround the opening when the door is in a closed position, each rail connected with at least two adjacent rails, each rail extending linearly along a longitudinal direction, at least one rail comprising
a main body that includes a base having an attachment side and a sealing side that is opposite to the attachment side, the attachment side providing an attachment surface for attachment to a body of the appliance;
a dart protruding orthogonally from the attachment side of the base and configured for attaching the gasket to the appliance;
a first pocket attached to the sealing side of the base, the first pocket providing a sealing surface for contact around an opening of the appliance, the first pocket defining a first chamber on the sealing side of the base;
a second pocket attached to the first pocket such that the first pocket is located between the second pocket and the base; and
at least one internal component located within the first chamber of the first pocket, the internal component not attached to the main body.

14. The gasket for an appliance as in claim 13, wherein the internal component has a first durometer and the first pocket has a second durometer, and wherein the first durometer is greater than the second durometer.

15. The gasket for an appliance as in claim 13, wherein the internal component has a first durometer and the first pocket has a second durometer, and wherein the first durometer is equal to the second durometer.

16. The gasket for an appliance as in claim 13, wherein the first pocket has a maximum pocket width along a direction orthogonal to the longitudinal direction, and wherein the at least one internal component comprises a tube having a tube diameter that is less than the maximum pocket width.

17. The gasket for an appliance as in claim 13, wherein the at least one internal component comprises a tube not attached to the main body.

18. The gasket for an appliance as in claim 13, wherein the internal component comprises at least two tubes connected together along a longitudinal direction.

19. The gasket for an appliance as in claim 13, wherein the at least one internal component comprises at least two tubes inserted into the first chamber, the at least two tubes not attached to the main body.

20. A resilient gasket for an appliance, the gasket defining a longitudinal direction, the gasket comprising:
a main body that includes
a base having an attachment side and a sealing side that is opposite to the attachment side, the attachment side providing an attachment surface for attachment to a body of the appliance;
a dart protruding from the attachment side of the base and configured for insertion into the appliance;
a pocket attached to the sealing side of the base, the pocket providing a sealing surface for contact around an opening of the appliance, the pocket defining a chamber on the sealing side of the base; and
at least two tubular internal components located within the chamber of the pocket, the internal components not attached to the main body;
wherein the main body and the internal component each extend along the longitudinal direction of the gasket.
